(19) United States
(12) Patent Application Publication
(10) Pub. No.: US 2011/0175769 A1
(43) Pub. Date: Jul. 21, 2011

(54) Microwave Sensor

(75) Inventors: Jae Jin Lee, Daejeon (KR); Chung Hwan Kim, Daejeon (KR); Min Gun Kim, Daejeon (KR)

(73) Assignee: TELTRON, INC., Daejeon (KR)

(21) Appl. No.: 12/910,314

(22) Filed: Oct. 22, 2010

(30) Foreign Application Priority Data
Jan. 19, 2010 (KR) 10-2010-0004610

(51) Int. Cl. G01S 13/00

(52) U.S. Cl. 342/175

(57) ABSTRACT

Microwave sensor includes an oscillator for generating microwave signals, a power divider for dividing the microwave signals, an antenna for transmitting the divided microwave signals to an outside of the microwave sensor and receiving microwave signals reflected from an object, and a mixer for detecting differences between the microwave signals received through the antenna and the signals input from the power divider and outputting Intermediate Frequency (IF) signals. The antenna includes a ground plate, an antenna pin located at a center of the ground plate, and a metallic wall formed along a circumference of the ground plate. Accordingly, the microwave sensor is advantageous in that it has uniform gain characteristics regardless of an azimuth angle by using a single antenna, functioning as both transmitting and receiving antennas, and a circuit for operating the antenna.

### CROSS-REFERENCE TO RELATED APPLICATION

This application claims the priority of Korean Patent Application No. 10-2010-0004610, filed Jan. 19, 2010 in the Korean Patent Office, which is incorporated herein by reference in its entirety.

### BACKGROUND

1. Field of the Invention

The invention relates, in general, to microwave sensors, and, more particularly, to a microwave sensor, which has a circular sensing area.

2. Description of the Related Art

Generally, security sensors are devices for sensing the motion of an object. Infrared sensors, which are capable of conveniently defining a sensing area and are inexpensive, have been widely used as security sensors.

Such an infrared sensor divides a sensing area into a plurality of partitions, and determines whether a change in temperature has occurred in each partition of the sensing area, thus determining whether a human body is moving. However, an infrared sensor has a serious disadvantage in that when an intruder is disguised with a heat blocking mechanism, the sensor cannot sense the presence of the intruder.

Since a microwave sensor can easily detect through a heat blocking mechanism, it has the advantage of sensing objects without being influenced by specific heat blocking obstacles. However, a disadvantage of a conventional microwave sensor is that it cannot guarantee a circular sensing range required by a security service provider for the convenience of installation. This problem is due to the fact that the beam shapes of the antenna of a microwave sensor are not uniform according to azimuth angle, and that sensing distance is gradually reduced according to the distance in the direction of an azimuth angle having a high gain, and thus it is impossible to precisely define a sensing area.

FIG. 1 is a view showing a conventional microwave sensor. In FIG. 1, microwave signals generated by an oscillator 100 are divided by a power divider 110, so that part of the microwave signals are radiated to a moving object through a transmitting antenna 120, and the remaining microwave signals are input to a mixer 140 as Local Oscillator (LO) signals.

Here, the signals radiated through the transmitting antenna 120 are reflected from the moving object and received by a receiving antenna 130, and are then input to the mixer 140 as Radio Frequency (RF) signals. When the object is stationary, the LO signals and the RF signals have the same frequencies, whereas when the object is moving, the frequencies of the RF signals deviate from those of the LO signals due to the Doppler effect. Then, the mixer 140 detects the differences between the frequencies of the RF and LO signals.

Reference numeral 150, not described in FIG. 1, denotes an Intermediate Frequency (IF) output terminal.

FIG. 2 is a view showing a patch antenna 200 for a conventional microwave sensor. This patch antenna 200 can be used as both the transmitting antenna 120 and the receiving antenna 130 of FIG. 1. Such a patch antenna 200 generally has the characteristic that antenna gain in the direction of an E-plane in which signals are applied, and antenna gain in the direction of an H-plane perpendicular to the E-plane, exhibit different shapes, wherein the beamwidth in the E-plane direction is wider than that in the H-plane direction.

FIG. 3 is a graph showing the intensities of a sensed signal depending on distances in the conventional microwave sensor. The E-plane direction in which the beamwidth of the antenna gain is wide exhibits the characteristic of a gradual decrease in the intensities of the sensed signal. In contrast, the H-plane direction in which the beamwidth of the antenna gain is narrow exhibits the characteristic of a rapid decrease in the intensities of the sensed signal. Due to this, there is a problem in that when a microstrip patch antenna is used, it is difficult to implement a microwave sensor having a circular sensing area.

Unlike the conventional antenna, antennas which exhibit uniform gain characteristics regardless of azimuth angle include a dipole antenna, a monopole antenna, etc. However, even in the case of such an antenna, when two antennas for transmission and reception are used together, the symmetry therebetween may be upset due to the mutual influence therebetween. Therefore, there is required a sensor structure that uses a single antenna functioning as both transmitting and receiving antennas without separately using the transmitting antenna and the receiving antenna.

FIGS. 4A and 4B are views showing a conventional monopole antenna. The monopole antenna includes a pin part 400 and a ground surface 410. When such a monopole antenna is used as the antenna of a microwave sensor, gain characteristics are uniform according to azimuth angle, so that the intensities of a sensed signal are also uniform. However, a problem arises in that the intensities of the sensed signal are distributed over a wide area while gradually decreasing, thus making it difficult to precisely define a sensing area.

### SUMMARY

According to an embodiment of the invention, there is provided a microwave sensor, which includes a single antenna that functions as both transmitting and receiving antennas and that has uniform gain regardless of azimuth angle, and a sensor circuit that operates the single antenna.

According to an embodiment, the invention provides a microwave sensor, the microwave sensor including an oscillator for generating microwave signals, a power divider for dividing the microwave signals, an antenna for transmitting the divided microwave signals to an outside of the microwave sensor and receiving microwave signals reflected from an object, and a mixer for detecting differences between the microwave signals received through the antenna and the signals input from the power divider and outputting Intermediate Frequency (IF) signals, wherein the antenna includes a ground plate; an antenna pin located at a center of the ground plate; and a metallic wall formed along a circumference of the ground plate.

The antenna may further include a dielectric for protecting the antenna pin.

The metallic wall may be formed to be inclined towards the antenna pin within a range of angles from 60 to 90 degrees with respect to the ground plate.

The antenna may function as both transmitting and receiving antennas.

### BRIEF DESCRIPTION OF THE DRAWINGS

The above and other objects, features and advantages of the invention will be more clearly understood from the following detailed description taken in conjunction with the accompanying drawings, in which:

FIG. 1 is a schematic diagram showing a conventional microwave sensor;

FIG. 2 is a front view showing a patch antenna for a conventional microwave sensor;

FIG. 3 is a graph showing the intensities of a sensed signal depending on distances in a conventional microwave sensor;

FIG. 4A is a sectional view showing a conventional monopole antenna;

FIG. 4B is a plan view showing the conventional monopole antenna;

FIG. 5 is a schematic diagram showing a microwave sensor according to an embodiment of the invention;

FIG. 6A is a sectional view showing an antenna for the microwave sensor according to an embodiment of the invention;

FIG. 6B is a plan view showing an antenna for the microwave sensor according to an embodiment of the invention; and

FIG. 7 is a graph showing the intensities of a sensed signal depending on distances in the microwave sensor according to an embodiment of the invention.

### DESCRIPTION OF THE PREFERRED EMBODIMENTS

Hereinafter, the construction and operation of embodiments of the invention will be described in detail with reference to the accompanying drawings.

Reference now should be made to the drawings, in which the same reference numerals are used throughout the different drawings to designate the same or similar components.

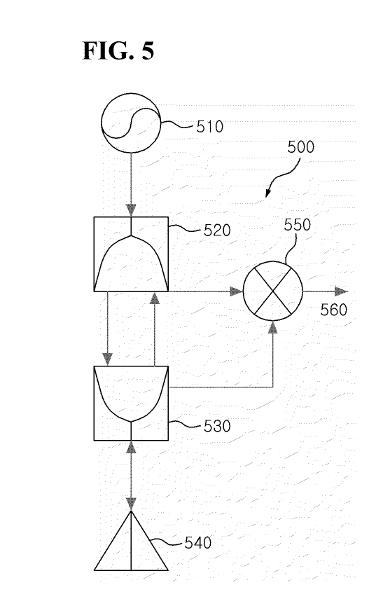

FIG. 5 is a schematic diagram showing a microwave sensor according to an embodiment of the invention.

As shown in FIG. 5, a microwave sensor 500 according to an embodiment of the invention includes an oscillator 510 for generating microwave signals, first and second power dividers 520 and 530 for dividing microwave signals, an antenna 540 for transmitting the divided microwave signals to the outside of the microwave sensor and receiving microwave signals reflected from an object, and a mixer 550 for detecting the differences between the microwave signals received by the antenna 540 and signals input from the power dividers and outputting Intermediate Frequency (IF) signals.

The microwave signals generated by the oscillator 510 of the microwave sensor 500 are divided by the first power divider 520, so that part of the microwave signals are input to the second power divider 530, and the remaining microwave signals are input to the mixer 550 as Local Oscillator (LO) signals. The microwave signals input to the second power divider 530 are not transferred to the mixer 550 due to the separation characteristics of the divider itself, and most of the microwave signals are transmitted (radiated) through the antenna 540.

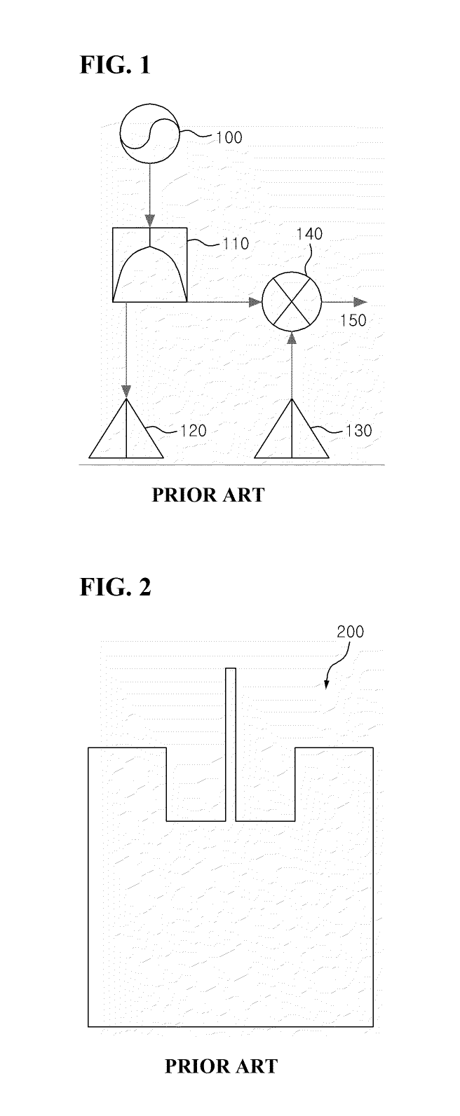

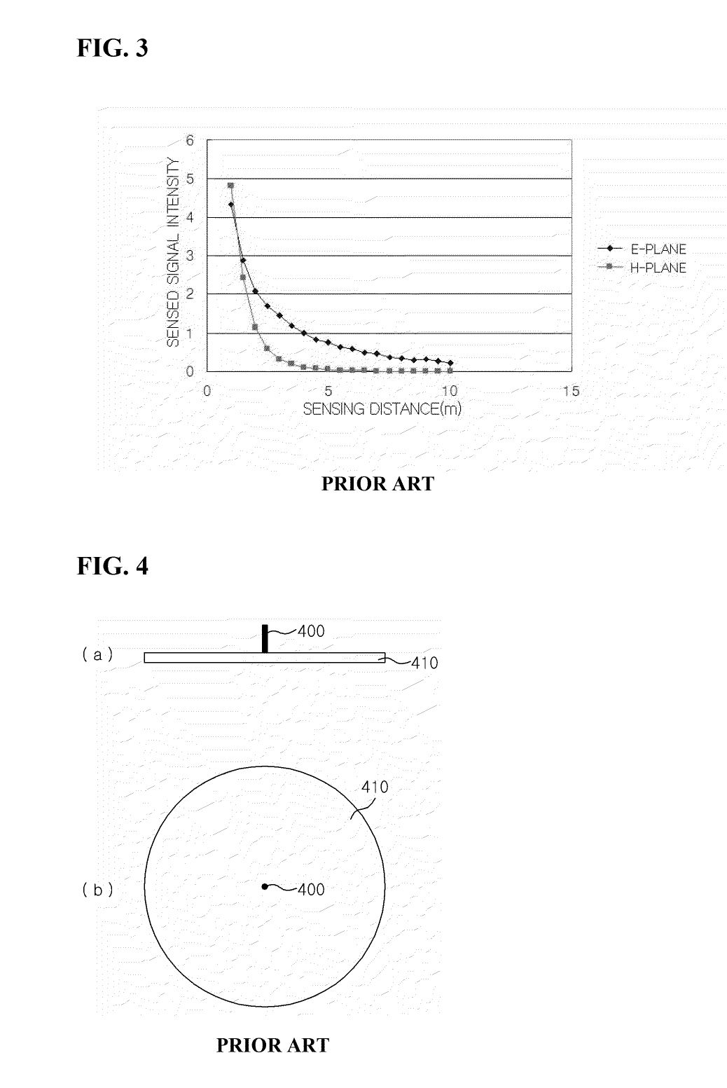

In this case, the microwave signals transmitted (radiated) through the antenna 540 are reflected from a moving object and are received again through the antenna 540. The received signals are divided, so that part of the received signals are transferred to the first power divider 520. The remaining signals are input to the mixer 550 as RF signals, so that IF signals which are the differences between the frequencies of the RF signals and LO signals are output from the mixer 550 when the object is moving. As described above, the structure of the microwave sensor 500 of FIG. 5 according to the embodiment of the invention has the advantage of using a single antenna that functions as both transmitting and receiving antennas, compared to the conventional sensor structure of FIG. 1.

Reference numeral 560, denotes an IF output terminal.

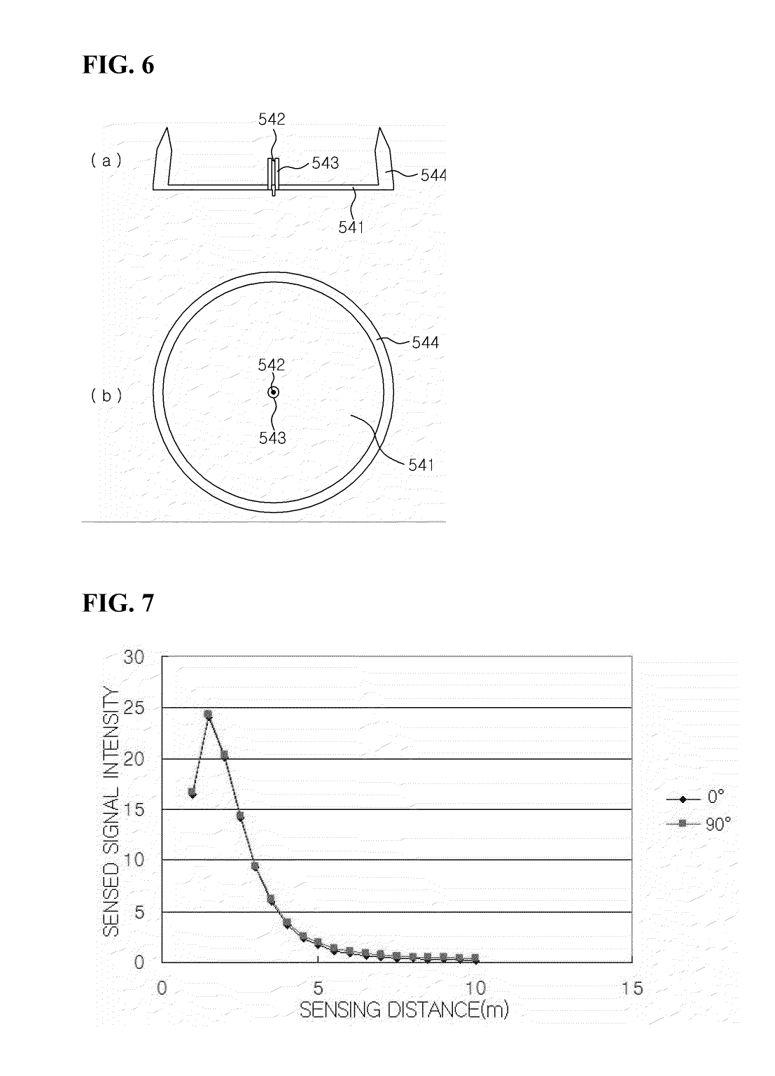

FIG. 6A is a sectional view showing an antenna for the microwave sensor according to an embodiment of the invention, and FIG. 6B is a plan view showing the antenna for the microwave sensor according to an embodiment of the invention.

As shown in FIGS. 6A and 6B, an antenna 540 for the microwave sensor according to the embodiment of the invention includes a ground plate 541, an antenna pin 542 located at the center of the ground plate, a dielectric 543 for protecting the antenna pin 542 from physical impact and guaranteeing the reproducibility of the assembly when the antenna is produced, and a metallic wall 544 formed along the circumference of the ground plate 541 and configured to prevent beams of the antenna 540 from spreading beyond the sensing area.

The metallic wall 544 is configured to be inclined towards the antenna pin 542 within the range of angles from 60 to 90 degrees with respect to the ground plate 541.

Further, the ground plate 541 and the metallic wall 544 are not limited to separate structures, and may be implemented as an integrated structure.

FIG. 7 is a graph showing the intensities of a sensed signal depending on distances in the microwave sensor according to an embodiment of the invention.

As shown in FIG. 7, the intensities of the sensed signal depending on distances in the microwave sensor 500 according to the embodiment of the invention do not change even when the sensing direction of the microwave sensor 500 changes to 0 degrees and 90 degrees in the direction of an azimuth angle. As the distance becomes larger, the intensities of the sensed signal decrease in a range exceeding the required distance, and thus it is possible to precisely define the sensing area (sensing distance).

The microwave sensor 500 according to the embodiment of the invention is advantageous in that it can obtain uniform gain regardless of azimuth angle by using the single antenna 540 which functions as both transmitting and receiving antennas, and a circuit which operates the single antenna 540.

Further, the microwave sensor 500 according to the embodiment of the invention is advantageous in that it has a circular sensing area thanks to the antenna 540 that includes the metallic wall 544.

As described above, the microwave sensor according to the invention is advantageous in that it can obtain uniform gain regardless of azimuth angle because a single antenna functioning as both transmitting and receiving antennas and a circuit for operating the single antenna are used.

Further, the microwave sensor according to the invention is advantageous in that it has a circular sensing area because an antenna including a metallic wall is used.

Although the preferred embodiments of the invention have been disclosed for illustrative purposes, those skilled in the art will appreciate that various modifications, additions and substitutions are possible, without departing from the scope and spirit of the invention as disclosed in the accompanying claims. Therefore, the scope of the invention should not be limited to the above-described embodiments and should be defined by the accompanying claims and equivalents thereof.

What is claimed is:

1. A microwave sensor comprising an oscillator for generating microwave signals, a power divider for dividing the microwave signals, an antenna for transmitting the divided microwave signals to an outside of the microwave sensor and receiving microwave signals reflected from an object, and a mixer for detecting differences between the microwave signals received through the antenna and the signals input from the power divider and outputting Intermediate Frequency (IF) signals, wherein the antenna comprises:
a ground plate;
an antenna pin located at a center of the ground plate; and
a metallic wall formed along a circumference of the ground plate.

2. The microwave sensor according to claim 1, wherein the antenna further comprises a dielectric for protecting the antenna pin.

3. The microwave sensor according to claim 1, wherein the metallic wall is formed to be inclined towards the antenna pin within a range of angles from 60 to 90 degrees with respect to the ground plate.

4. The microwave sensor according to claim 2, wherein the metallic wall is formed to be inclined towards the antenna pin within a range of angles from 60 to 90 degrees with respect to the ground plate.

5. The microwave sensor according to claim 1, wherein the antenna functions to both transmit and receive microwave signals.
